(19) United States
(12) Patent Application Publication
(10) Pub. No.: US 2023/0116334 A1
(43) Pub. Date: Apr. 13, 2023

(54) Inflatable Emergency Beacon Antenna and Associated Assemblies

(71) Applicant: Shakespeare Company, LLC, Greer, SC (US)

(72) Inventors: Gary A. Martek, Blythewood, SC (US); David Manasseh, Greer, SC (US)

(21) Appl. No.: 17/938,377

(22) Filed: Oct. 6, 2022

Related U.S. Application Data
(60) Provisional application No. 63/253,299, filed on Oct. 7, 2021.

(51) Int. Cl. H01Q 1/08; H01Q 11/08

(52) U.S. Cl. CPC H01Q 1/081; H01Q 1/085; H01Q 11/08

(57) ABSTRACT

An inflatable beacon antenna assembly includes an inflatable sock, an antenna, an attachment port, and a ballast. The inflatable sock may have an inflated state and a deflated state, where the inflatable sock assumes an elongated configuration in the inflated state. The antenna may extend along the length of the inflatable sock. The attachment port may be configured for operable connection to an inflation mechanism. Two or more integrated antennas can be used for multi-frequency VHF/UHF beacon operation and/or a GPS antenna for position location.

### CROSS-REFERENCE TO RELATED APPLICATIONS

This application claims priority to U.S. Provisional Patent Application No. 63/253,299, filed Oct. 7, 2021, which is incorporated herein by reference.

### TECHNICAL FIELD

The present disclosure relates to antennas, and in particular, to inflatable emergency beacon antennas and associated assemblies.

### BACKGROUND

Emergency radio beacons aboard aircraft and other vehicles depend on adjunct antenna(s) for the proper dissemination of crucial location coordinates to rescue vessels. Typically, GPS (Global Positioning System) data is retransmitted on an ultra-high frequency (UHF) radio carrier to rescue vehicles. Two lower frequency, very-high frequency (VHF), signals are also transmitted from the emergency radio beacon for radio direction finder (RDF) locating.

Legacy antenna(s) used in conjunction with such beacons are known to be unreliable. This is due, at least in part, to antenna breakage during deployment and occurrences of the antennas sinking when aircraft evacuation is over bodies of water. Thus, improved antennas for use with emergency radio beacons and other safety and rescue equipment are desirable.

### SUMMARY

In one aspect, an inflatable beacon antenna assembly is provided, including an inflatable sock having an inflated state and a deflated state. The inflatable sock assumes an elongated configuration in the inflated state. A three frequency very high frequency (VHF)/ultra-high frequency (UHF) antenna extends along a length of the inflatable sock. A ballast is positioned at or near a first end of the inflatable sock, the ballast being effective to maintain the antenna assembly upright in water. An attachment port is configured for operable connection to an inflation mechanism to selectively inflate the inflatable sock.

In another aspect, an emergency position-indicating radio beacon assembly is provided, including an emergency position-indicating radio beacon and an inflatable beacon antenna assembly. A feed cable is coupled to the beacon and to the antenna assembly, and is configured to transfer information between the antenna and a transmitter, receiver, or transceiver of the emergency position-indicating radio beacon.

In yet another aspect, a structural assembly is provided, including a structural component and an inflatable beacon antenna assembly mounted on the structural component. The structural component may be a bag with a stiffened portion, an inflatable life raft, a shipping container, or other search and rescue equipment.

### BRIEF DESCRIPTION OF THE DRAWINGS

The detailed description is set forth with reference to the accompanying drawings illustrating examples of the disclosure, in which use of the same reference numerals indicates similar or identical items. Certain embodiments of the present disclosure may include elements, components, and/or configurations other than those illustrated in the drawings, and some of the elements, components, and/or configurations illustrated in the drawings may not be present in certain embodiments.

FIG. 1 is a top view of one embodiment of an inflatable antenna according to the concepts of the present disclosure.

FIG. 2 is a side view of the inflatable antenna of FIG. 1 according to the concepts of the present disclosure.

FIG. 3 is a side cross-sectional view of one embodiment of an antenna assembly prior to inflation according to the concepts of the present disclosure.

FIG. 4 is a partial cross-sectional plan view of one embodiment of an inflatable sock and an emergency beacon tri-frequency inflatable antenna assembly, according to the concepts of the present disclosure.

FIG. 5 is a front perspective view of one embodiment of a bag for an inflatable antenna assembly according to the concepts of the present disclosure.

FIG. 6 is a rear perspective view of the bag of FIG. 5 having a series of loop fastener strips according to the concepts of the present disclosure.

FIG. 7 is a side view of the inflatable antenna of FIG. 1 in an inflated state according to the concepts of the present disclosure.

FIG. 8 is a side view of one embodiment of an inflatable antenna in an inflated state and coupled to a structure according to the concepts of the present disclosure.

FIG. 9 is a front view of one embodiment of an emergency beacon tri-frequency antenna according to the concepts of the present disclosure.

FIG. 10 is a detailed perspective view of an emergency beacon tri-frequency antenna according to the concepts of the present disclosure.

FIG. 11 is a magnified view of a portion of FIG. 10, showing the lower trap assembly with traversing coaxial cable of the emergency beacon tri-frequency antenna of FIG. 10 according to the concepts of the present disclosure.

FIG. 12 is a magnified view of a portion of FIG. 10, showing the upper trap circuit detail of the emergency beacon tri-frequency antenna of FIG. 10 according to the concepts of the present disclosure.

FIG. 13 is a perspective view of an inductor coil according to the concepts of the present disclosure.

FIG. 14 is a perspective view of a coil form according to the concepts of the present disclosure.

FIG. 15 is a perspective view of a coil wound coil form according to the concepts of the present disclosure.

FIGS. 16A-C are perspective and partial perspective views of an inflatable antenna assembly including a stress transfer mechanism according to the concepts of the present disclosure.

FIG. 17 is a partial perspective view of an actuation mechanism for an inflation mechanism of an inflatable antenna assembly according to the concepts of the present disclosure.

FIG. 18 is a cross-sectional view of one embodiment of an inflatable antenna having a ballast weight according to the concepts of the present disclosure.

FIG. 19 is front view of one embodiments of an emergency beacon tri-frequency inflatable antenna assembly according to the concepts of the present disclosure.

FIG. 20 is left side view of the emergency beacon tri-frequency inflatable antenna assembly of FIG. 19, showing the manual inflation tube, according to the concepts of the present disclosure.

FIG. 21A is right side view of the emergency beacon tri-frequency inflatable antenna assembly of FIG. 19, showing the CO₂ actuator, according to the concepts of the present disclosure.

FIG. 21B is a magnified view of the CO2 actuator of FIG. 21A, according to the concepts of the present disclosure.

FIG. 22 is a front view of a helical GPS antenna according to the concepts of the present disclosure.

FIG. 23 is a front view of a GPS flotation device according to the concepts of the present disclosure.

FIG. 24 is a front view of the helical antenna of FIG. 22 inside the dedicated flotation device of FIG. 23 according to the concepts of the present disclosure.

FIG. 25 is a perspective view of an inflatable antenna assembly including a descent stabilization mechanism according to the concepts of the present disclosure.

FIG. 26 is a schematic view of an emergency beacon in an inflated condition utilizing an inflatable antenna assembly according to the concepts of the present disclosure.

### DETAILED DESCRIPTION

Referring now to the drawings, exemplary illustrations are shown in detail. The various features of the exemplary approaches illustrated and described with reference to any one of the figures may be combined with features illustrated in one or more other figures, as it will be understood that alternative illustrations that may not be explicitly illustrated or described may be able to be produced. The combinations of features illustrated provide representative approaches for typical applications. However, various combinations and modifications of the features consistent with the teachings of the present disclosure may be desired for particular applications or implementations. The representative illustrations described below relate generally to antennas and in particular to inflatable emergency antennas. Artisans may recognize similar applications or implementations with other technologies and configurations.

Inflatable emergency beacon antennas and assemblies are described herein. These assemblies may contain or be configured to be operably connected to emergency search and rescue beacon equipment, such as Emergency Position Indicating Radio Beacons (EPIRB), Emergency Locator Transmitters (ELTs), and Personal Locator Beacons (PLBs). The inflatable antenna assemblies described herein have been found to provide a significant improvement to known adjunct antennas that are used with such beacons, resulting in a critical enhancement to the dissemination of crucial location coordinates to rescue vessels.

The inflatable antennas disclosed herein may be provided in various configurations and structures. The assembly may efficiently store the inflatable antenna, such that the inflatable antenna assumes an inflated state only in emergency situations. Thus, the inflatable antennas described herein may have increased range while also being stowable in a small volume. Potential applications for the inflatable antennas and assemblies described herein include marine, military, emergency/rescue, camping, developing nation/remote area infrastructure, and shipping. The antennas described herein may be particularly suited for deployment in marine military rescue applications.

In certain embodiments, an inflatable beacon antenna assembly of the present disclosure contains (i) an inflatable sock having an inflated state and a deflated state, wherein the inflatable sock assumes an elongated configuration in the inflated state, (ii) a three frequency very high frequency (VHF)/ultra-high frequency (UHF) antenna extending along a length of the inflatable sock, (iii) a ballast at or near a first end of the inflatable sock, the ballast being effective to maintain the antenna assembly upright in water, and (iv) an attachment port configured for operable connection to an inflation mechanism. Beneficially, the three frequency VHF/UHF antenna may be effective to transmit GPS (Global Positioning System) data on a UHF radio carrier to rescue vehicles, while also transmitting two VHF signals from the emergency radio beacon for radio direction finder (RDF) locating. In other embodiments, the antenna may contain only one or two integrated antennas; however, it has been found that the multi-frequency, in particular three-frequency, operation is specifically effective for the desired search and rescue applications.

Beneficially, the inflatable antenna assemblies described herein may have an integrated ballast that is effective to position the antenna in a suitable transmission position when in water or on a solid surface. That is, the inflatable antenna may be configured to provide buoyancy and clear signal path for all emergency radio traffic. As used herein, the phrase “at or near a first end” refers to the ballast being positioned at the first end or adjacent the first end (e.g., between the longitudinal center of the inflatable sock and the first end). The ballast may be directly or indirectly coupled to the inflatable sock, such as by similar mechanisms described herein with reference to attachment of the antenna to the inflatable sock.

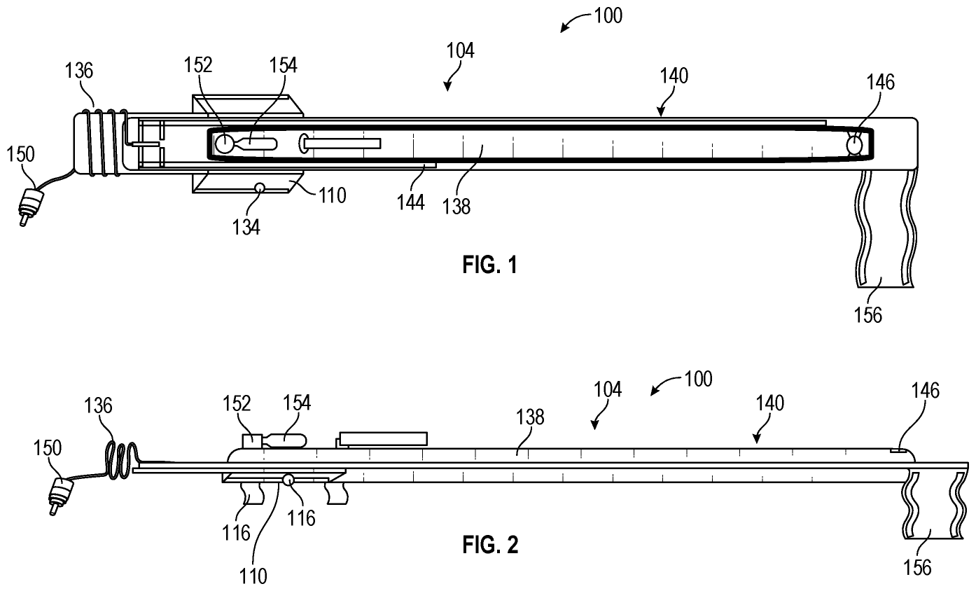

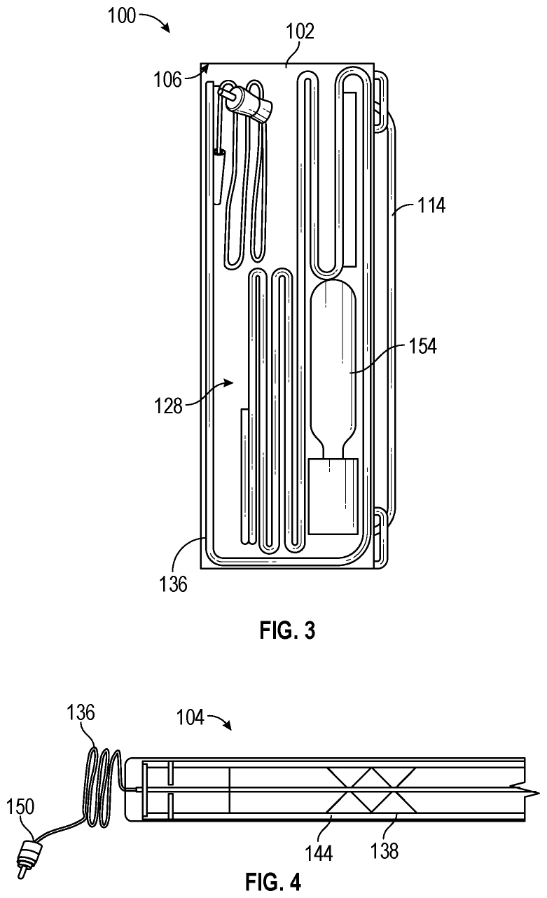

In some embodiments, as shown in FIGS. 1 and 2, the inflatable antenna assembly 100 includes an inflatable antenna 104 configured to assume an inflated state. For example, the inflatable antenna 104 may have a deflated state (see FIG. 3) and an inflated state as shown in FIGS. 1 and 2. As used herein, the phrase “inflated state” refers to the inflatable antenna system being in an expanded shape due to gas or liquid substantially filling the interior volume of the inflatable antenna. As used herein, the phrase “deflated state” or “uninflated state” refers to the antenna system being substantially empty of an expanding material such as gas or liquid.

In some embodiments, as shown in FIGS. 1, 2, and 4, the inflatable antenna 104 includes an inflatable sock 138 (e.g., bladder, container) configured to expand into a predefined shape. For example, the inflatable sock 138 may expand when filled with gas to an inflated state 140 and form an elongated shape (i.e., a shape having a length greater than its width). The inflatable antenna 104 may be configured to manually or automatically inflate, such as by a suitable inflation mechanism including a pump, gas canister, or breath of a user through a suitable valve or straw, as will be discussed in greater detail below. That is, the inflation mechanism may be any suitable inflation mechanism known to provide the flow of gas effective to inflate the container. Additional inflation mechanisms are known to those skilled in the relevant art and may be integrated into the inflatable antenna systems described herein.

In some instances, the inflatable sock 138 may have a substantially circular cross-sectional shape. In other instances, the inflatable sock 138 may have a rectangular, square, elliptical, triangular, or another type of cross-sectional shape. In certain embodiments, the inflatable sock 102 has an inflated length of at least 0.1 meter. For example, the inflatable sock 138 in an inflated state 140 may have a length of from about 0.1 meter to about 10 meters, such as from about 1 meter to about 10 meters, from about 1 meter to 5 meters, or from about 1 meter to about 3 meters. The inflatable sock 138 may expand to about 1.5 meters long. As used herein, the term “about” means the specified value for a particular unit of measurement may be accurate with an increase or decrease of ten percent of the specified value.

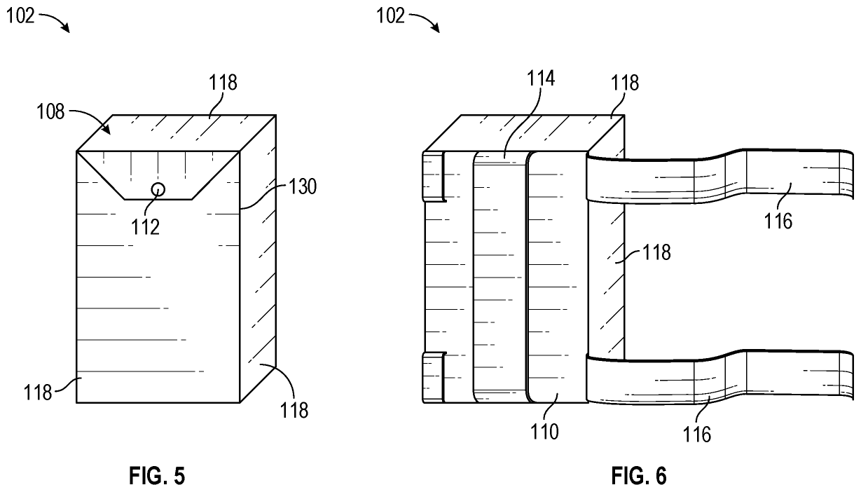

In certain embodiments, as shown in FIGS. 5 and 6, the inflatable sock 138 may be disposed within a bag 102 or another suitable container, or associated with a suitable structure (e.g., search and rescue equipment, such as parachute, ejector seat, life raft or other flotation equipment), substrate and/or inflation mechanism in a deflated state 142. For example, the inflatable sock 138 in a deflated state 142 may be configured to be rolled or folded into a compact shape. For example, the inflatable sock 138 may be flat and flexible in its deflated state 142.

In some instances, the inflatable sock 138 may be composed of plastic, rubber, nylon, neoprene or some other suitable material (or a material having a coating) that is substantially impermeable to trapped gas or liquid (e.g., is waterproof). For example, the inflatable sock 138 may be substantially airtight or gastight, such that it can be inflated with air or other appropriate gas so as to unfurl or uncoil the sock and maintain an inflated state 140 for a period (e.g., at least one day, or a period of about one day to about seven days).

In certain embodiments, the fabric material forming the sock or a portion thereof may be a reflective or otherwise brightly colored (e.g., international orange) and/or easy-to-see material. In other embodiments, such as for military applications, the antenna assembly, such as the inflatable sock, maybe camouflaged. In some embodiments, the inflatable antenna assembly 100 includes a light or other reflective features, such as to facilitate emergency locating.

In some embodiments, as shown in FIGS. 1 and 2, the inflatable antenna assembly 100 includes a light 146. For example, the light 146 may be a light-emitting diode. The light 146 may be disposed at one end of the inflatable antenna 104. For example, such a light 146 may be powered by a battery or a separate power cord, or through a coaxial cable that connects the antenna to a radio. In the latter configuration, the power may be injected through an in-line power injector and filtered out for use at the antenna end.

In some instances, the light 146 may be a different type of light, such as a fluorescent tube, a neon lamp, a high-intensity discharge lamp, a low-pressure sodium lamp, a metal halide lamp, a halogen lamp, a compact fluorescent lamp, or an incandescent lamp. In some instances, the inflatable antenna assembly 100 may have one light 146. In other instances, the inflatable antenna assembly 100 may have multiple lights disposed along the interior and/or exterior surfaces of the inflatable antenna 104 and/or bag 102.

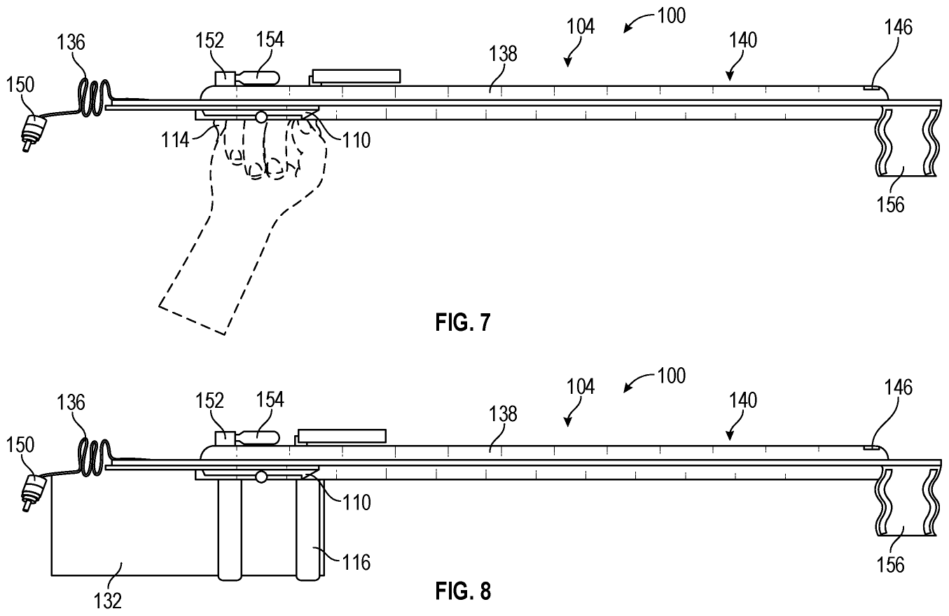

In some embodiments, as shown in FIGS. 1, 2, 7, and 8, the inflatable antenna assembly 100 includes a flag 156 configured to improve the visibility of the inflatable antenna 104. For example, the flag 156 may be a flexible material and lined with reflective material. For example, the flexible material may be a fabric such as cotton, linen, nylon, or other fabric. The reflective material on the flag 156 may be a fluorescent fabric. For example, having the flag 156 at one end of the inflatable antenna may increase visibility in case of rescue or signaling distress. In certain embodiments, flag 156 is formed of a conductive material, or a material that is a poor conductor but is a radar-reflective material (e.g., Mylar), and is dimensioned such that it provides a resonant and highly reflective target for a search and rescue radar (i.e., at rescue search radar frequencies). Such a flag would further aid efforts to locate a downed pilot or other search and rescue targets by providing a strong target to the search and rescue radar.

In certain embodiments, the inflatable sock 138 may include a sealable attachment port 152 (see FIGS. 1, 2, 7, and 8) configured to provide an inlet for the inflating air, as described in greater detail below.

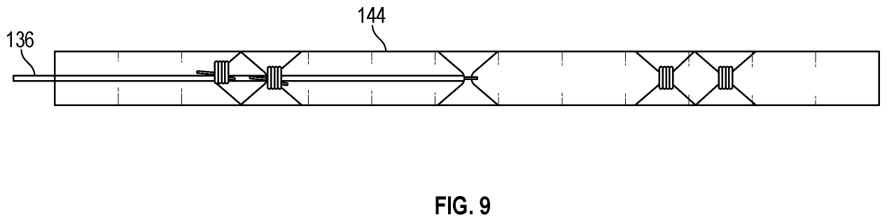

In some embodiments, as shown in FIGS. 5 and 9, the inflatable sock 138 of the inflatable antenna 104 contains an antenna 144 (which may be formed of one or more antenna sections or portions). The antenna 144 may attach to an interior or exterior surface of the inflatable sock 138, or some combination of both. For example, the antenna 144 may be attached to an interior surface of the inflatable sock 138 by adhesive, mechanical fastening means, or another suitable fastener. In some instances, the antenna 144 may attach to another surface of the inflatable antenna 104. In some instances, the antenna 144 may be embedded within stitching of the inflatable sock 138. In some instances, the antenna 144 may be embedded within the material of the inflatable sock 138. In some instances, the antenna 144 may attach to an exterior surface of the inflatable sock 138. In some instances, the antenna 144 may extend along less than the entire length of the inflatable sock 138.

Thus the antenna 144 may be coupled, directly or indirectly, to at least some portion of the inflatable container 138 (e.g., sock) and/or another inflatable section or portion of the assembly or device. For example, the antenna 144 may be glued, stitched, welded, crimped, or otherwise attached directly to the material forming the inflatable container or section, or to another material or support structured associated with the material forming the inflatable container or section. For example, in certain embodiments, one or more sections of the antenna are first attached to a sheet or sleeve which is then associated to the inflatable container or a supporting structure within it.

In certain embodiments, the antenna (or the collection of sections forming the antenna) extends along the interior or exterior surface of the inflatable container (e.g., sock). Again, the antenna may be coupled directly or indirectly to the body or material forming the inflatable container. Generally, the phrase “extending along a surface of the inflatable sock/container” refers to the antenna being disposed along some length of the container, such that in the inflated state, the antenna is unfurled or uncoiled to an operable, extended configuration.

In some instances, the antenna 144 may wrap spirally or in some other manner around the inflatable sock 138. In other instances, the antenna 144 may follow one or more straight paths along the inflatable sock 138, e.g., the antenna may extend in a longitudinal direction that is substantially parallel with the length of the elongated sock.

In certain embodiments, the antenna 144 extends along only a partial length of the inflatable sock 138. For example, the antenna 144 may extend about 70 percent of the length of the inflatable sock 138. For example, the antenna 144 may extend between about 50 percent to about 100 percent of the length of the inflatable sock 138. In certain embodiments, the antenna 144 has a length that is at least about 50 percent of the length of the inflatable sock, such as at least about 75 percent of the length of the inflatable sock, or at least about 85 percent of the length of the inflatable sock.

For example, the antennas and assemblies described herein beneficially may provide an efficiently stowable full-size antenna. In certain embodiments, the antenna itself has a length of at least about 10 cm, such as about 50 cm to about 200 cm. For example, the antenna 144 may be about 130 centimeters to about 140 centimeters. In other instances, the antenna may be less than 130 centimeters or above 140 centimeters. For example, the antenna may be at least one meter in length but stowable in a package having a major dimension of one foot or less, such as about a 10 inch or smaller container.

For example, the inflatable antennas described herein may offer an unobtrusive and resilient full three frequency beacon antenna that can be stored in a dimension of about 250 mm or less and inflated when required. Thus, these antennas may be used in areas where VHF/UHF beacon signal transmission is needed and where it has historically been hard to get an antenna. Conventional emergency/temporary antennas are about 6 to about 8 inches long and have limited performance (e.g., about 1 dB gain). Thus, the antennas described herein offer increased performance as compared to traditional equipment.

Moreover, traditional extendable antennas utilize a rigid telescoping design, which is prone to breakage. The flexible antenna designs described herein are relatively easy to store and quickly extend to full size, without the need for careful deployment of a telescoping antenna and the risk of damaging the antenna during deployment. In other words, when in the inflated state 140, the material of the inflatable sock remains flexible or non-rigid, so as to allow the inflatable antenna to deflect at its connection point to a transmitter, as will be discussed, so as to avoid or minimize damage that might otherwise occur. The inflatable antenna is also flexible along its length to absorb any impacts and then return to its original inflated state with minimal loss of signal performance.

In some embodiments, as shown in FIG. 9, the antenna 144 is flexible three frequency beacon antenna. As used herein, the phrase “beacon antenna” refers to an antenna in the formation of a flexible rectangular shape. A beacon antenna formation may include broadband coverage and low angle radiation pattern. The antenna 144 may be another type of antenna formation, including a bow tie, log-periodic dipole array, short dipole, dipole, monopole, loop, helical, Yagi-Uda, rectangular microstrip, planar inverted-f, corner, or parabolic reflector antenna configured to be connected to a radio receiver and/or transmitter.

In some instances, the antenna 144 may be configured to transmit information. In other instances, the antenna 144 may be configured to receive information. The antenna 144 may be configured to transmit and receive signals. For example, the antenna 144 may be a very high-frequency antenna (VHF) and ultra-high frequency (UHF) combined. As used herein, the phrase “very high frequency” refers to a range for radio waves of about 30 megahertz (MHz) to about 300 MHz, “ultra high frequency” refers to a range of radio waves of about 300 MHz to about 3000 MHz. For example, the antenna 144 may be tuned to three frequencies of 121.5, 243, and 406 MHz for beacon operation. In certain embodiments, the antenna has a gain of at least 0 dBi and exhibits elevation radiation behavior for emergency search and rescue operation.

In one embodiment, the antenna 144 is a suitably flexible printed circuit board. For example, the flexible circuit board may be configured to fold when the inflatable sock 138 is in a deflated state 142. In other instances, the antenna 144 itself may not be flexible. For example, in certain embodiments, rigid antenna elements, sections, or portions, may be flexibly connected to provide the desired flexibility of the overall antenna assembly. For example, sections of the antenna may be embedded within sections or the inflatable structure by fitting between folds thereof. The antenna 144 may be composed of another type of metal or metal alloy, such as aluminum. In certain embodiments, the antenna is formed from a braided copper tape and/or a flexible antenna made from known flexible circuit board techniques. In some instances, the antenna 144 may be a flexible whip antenna. In certain embodiments, the antenna 144 is flexible and its inductor coils are protected by flexible coil forms in the deflated state.

In certain embodiments, as shown in FIG. 9, the inflatable antenna assembly 100 further includes a feed cable 136 coupled to the antenna, wherein the feed cable is configured to transfer information between the antenna and an emergency beacon transmitter, receiver, or transceiver. For example, as shown in FIGS. 1, 2, and 4, the antenna 144 may be coupled to a feed cable 136 configured to transfer information between the antenna 144 and a beacon transmitter (not shown) and/or beacon radio receiver (not shown). The feed cable 136 may be a radio frequency (RF) feed cable for the antenna 144.

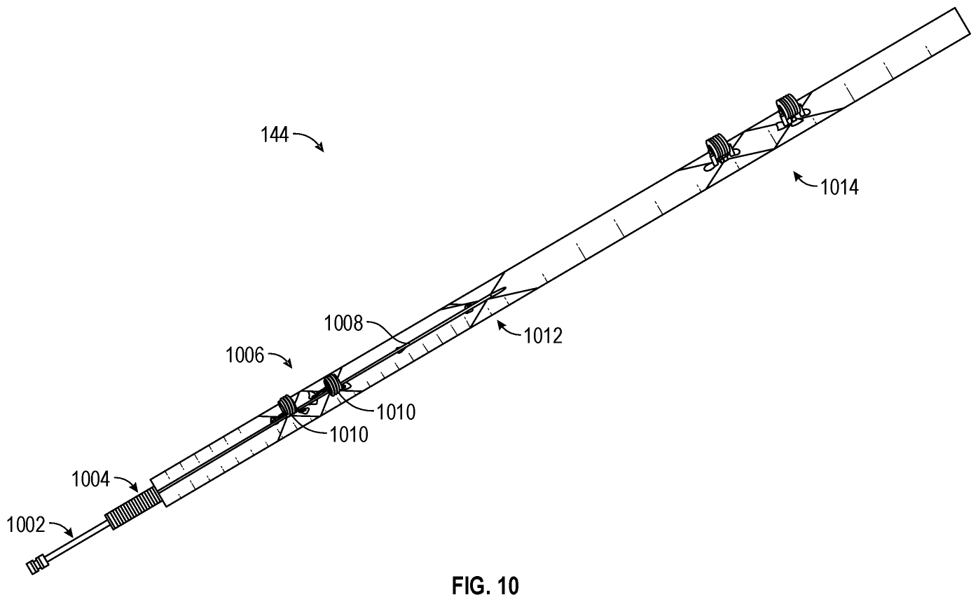

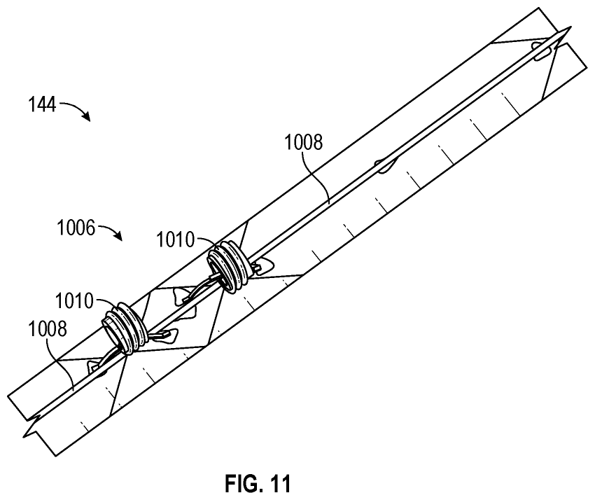

FIG. 10 isolates the three-frequency beacon antenna 144 from the inflatable system for the purpose of detailed explanation of the associated electrical properties of the antenna. As shown, an input connector 1002 provides connection to the beacon equipment (not shown). In some embodiments, input connector 1002 is a feed cable 136. A choke bead assembly 1004 assures the proper isolation of the antenna function from the connecting transmission line, which preserves the radiation behavior of the antenna. Lower trap circuits 1006 make possible the operation of one antenna structure on several frequencies simultaneously. Here, the inductors are created by shaping the connecting coaxial line 1008 into coil shapes 1010 of the proper geometry as shown in the magnified view of FIG. 11. The coaxial cable 1008 continues along the length of the flexible board to allow connection to the central feed terminals 1012. The circuits may be tank circuits in which capacitors bridge the inductor coils (see FIG. 11). Upper trap circuits 1014 are formed from inductor/capacitor combinations and similarly enable one antenna structure to operate on several frequencies simultaneously.

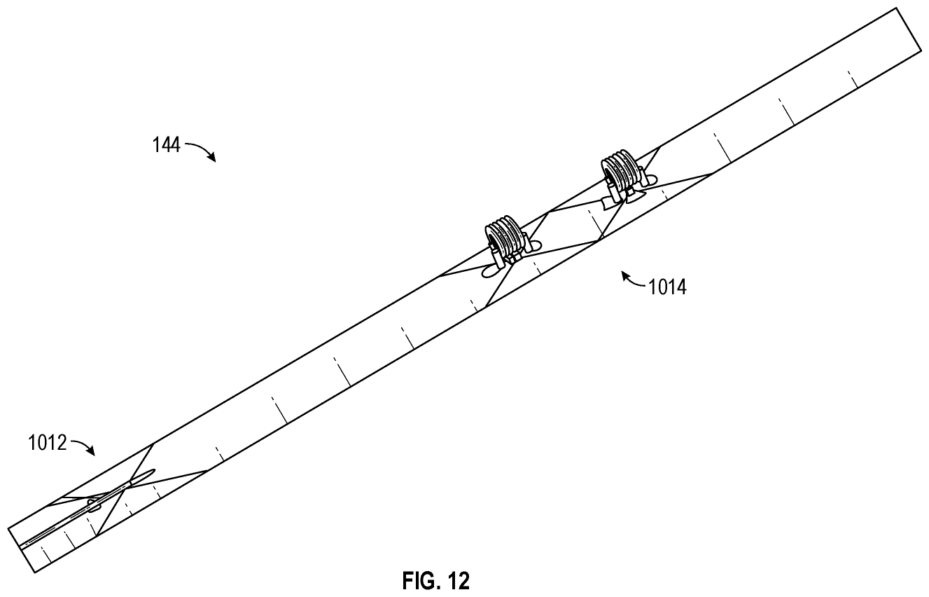

FIG. 12 illustrates one embodiment of the inductor/capacitor combination making up the upper trap circuits 1014. These circuits are not necessarily shaped from conformal coaxial cable as discussed with reference to FIG. 10. These circuits can be made from conformal cable but are not required to be, unless the system requirements require yet another antenna specifically like a GPS (Global Positioning System). The GPS antenna could also be incorporated into the beacon antenna flotation system, above the three-frequency flexible antenna, as discussed further herein.

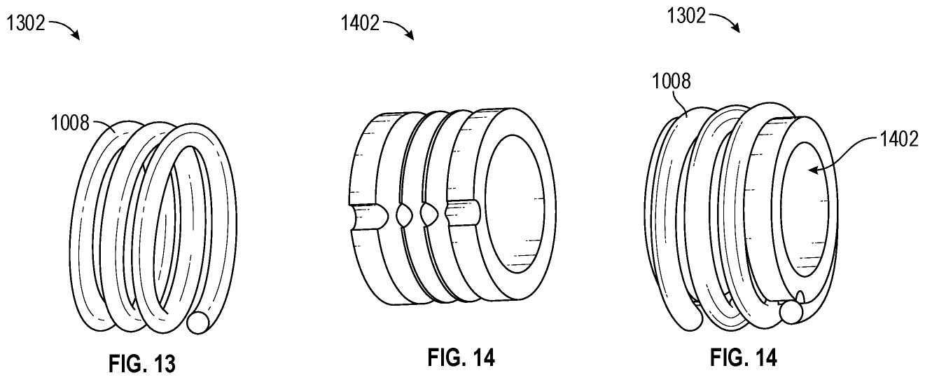

FIG. 13 shows a section of the conformal coaxial cable 1008 shaped into an air-wound inductor coil 1302. Because the beacon antenna has to be rolled up or otherwise collapsed for storage in the deflated state, the inductor coil 1302 is susceptible to being crushed. FIG. 14 shows a pliable coil form 1402 to which the air-wound inductor 1302 of FIG. 13 is wound upon producing the coil. An air-wound inductor coil 1302 wound on the coil form 1402 shown in FIG. 15. Beneficially, the coil form 1402 protects/preserves the coil geometry when the antenna is in the rolled up or uninflated state, allowing for an improved signal transmission that is able to be folded or rolled without damaging the antenna.

As used herein, the phrase “feed cable” refers to a cable that carries radio signals from a radio antenna to a transmitter or receiver. In some instances, the feed cable 136 is a coaxial cable. For example, the coaxial feed cable 136 may include two circular conductors, where one conductor is located within another conductor. In other instances, the feed cable 136 may be a ladder line. For example, the ladder line may be a feed cable 136 having two parallel wires separated by insulating material. In some embodiments, the feed cable 136 has an impedance value of 50 ohms. In other embodiments, the feed cable 136 has an impedance greater than or less than 50 ohms. At the end of the feed cable 136 may be a connector 150 that attaches to a radio or transmitter (not shown). In some instances, the connector 150 may be an ultra high frequency (UHF) connector. In other instances, the connector 150 may be another type of connector such as Subminiature Version A, Female Version A, Bayonet Neill-Concelman, Threaded Neill-Concelman, or Type N connector. The connector 150 may fit within the bag 102 (as shown in FIG. 3) and be configured to plug into a receiver or transmitter. In certain embodiments, the feed cable 136 further forms inductor coils to provide functioning of multi-frequency trap circuits, allowing for multi-frequency operation.

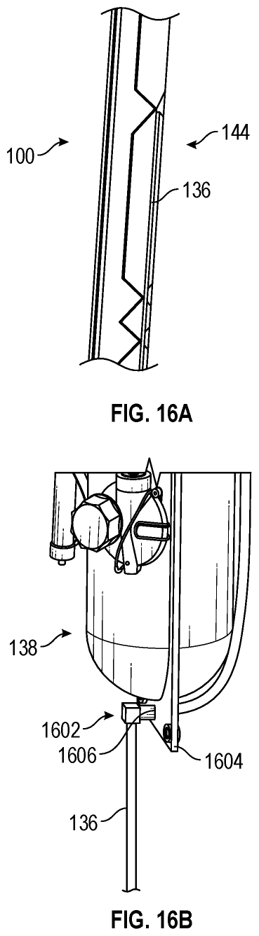

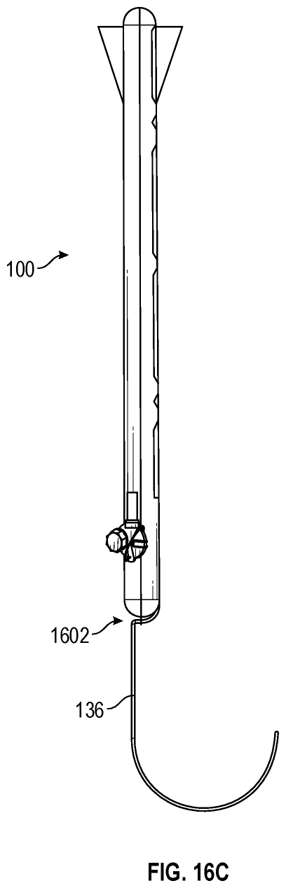

In certain embodiments, as shown in FIGS. 16A-C, the inflatable antenna assembly includes a stress transfer mechanism 1602 configured to lessen or remove stress to the antenna cables and feed connection (e.g., to the connection of the feed cable). For example, the stress transfer mechanism may beneficially eliminate undue stress or forces incident on the antenna cables and feed connection during the ejection process in a military rescue situation. FIG. 16A illustrates the feed cable connection 136 to the antenna 144 of the inflatable antenna assembly 100. FIG. 16B illustrates one embodiment of a stress transfer mechanism 1602 extending from the first end of the elongated inflatable sock 138. In particular, the stress transfer mechanism 1602 includes a frame or flange 1604 extending from the outer surface of the elongated inflatable sock 138 at its first end, the frame having an aperture 1606 therethrough, through which the feed cable 136 is disposed for connecting the antenna to ancillary equipment, such as a beacon. For example, the frame may be a relatively rigid material and may be dimensioned and shaped to space the cable from the first end of the elongated sock, to thereby minimize the incidence of potentially damaging stress forces directly on the elongated sock, transferring those forces to the frame of the sock and thereby providing relief to the cable to antenna connection. In some embodiments, the cable extends along the elongated sock in a direction parallel to the longitudinal axis of the sock and then turns approximately 90 degrees to the bulkhead connector at the frame/flange supporting the sock at the first end. It has been found that this configuration relieves stress from the antenna.

In some embodiments, as in FIGS. 1 and 2, the inflatable antenna 104 includes an attachment port 152, an inflation mechanism, such as inflation canister 154, and a firing pin 134. The firing pin 134 may be configured to selectively puncture a seal of the canister to inflate the inflatable sock. In one embodiment, the inflation canister 154 is attached to the attachment port 152 and the firing pin 134 may be pulled to puncture the inflation canister 154. The inflation canister 154 may then release the compressed gas within the canister so as to enter the inflatable sock 138 to assume an inflated state 140 from the deflated state.

In some instances, the attachment port 152 may be a one-way breathable port configured to receive air within the inflatable sock 138 to allow for manual inflation. In other instances, the attachment port 152 may be a two-way breathable port configured to receive and release air from within the inflatable sock 138. For example, the attachment port 152 may be a ball valve, butterfly valve, check valve, diaphragm valve, directional valve, float valve, knife valve, globe valve, pinch valve, needle valve, poppet valve, or plug valve. The inflatable antenna assembly 100 may have one valve or may have multiple valves along the exterior of the inflatable antenna 104.

The attachment port 152 may be configured to be coupled to (i.e., in fluid communication with) a canister 154 filled with gas. In one embodiment, the canister 154 may be a carbon dioxide canister configured to be sealed until punctured by the firing pin 134. The canister 154 may be filled with another gas, such as hydrogen, or with the precursor components of a two-part foam material that may be combined upon actuation. In some instances, the canister 154 may be for one-time use. In other instances, the canister 154 may be refillable for multiple uses. In other instances, the inflatable sock 138 may couple to a pump configured to inflate the inflatable sock 138.

The canister 154 may be a cylinder shaped to store within the bag 102 and be adaptable for replacement. For example, the cylinder may narrow at one end to attach to the attachment port 152. The narrow end of the canister may be a circular port (not shown) covered by a thin metal skin or seal. The firing pin 134 may puncture the circular port to release the gas within the canister 154. In some instances, the firing pin 134 is positioned between the canister 154 and the attachment port 152 to release air inside canister into the attachment port 152. In other instances, the firing pin 134 is located in the bag 102 and may be manually used to puncture the canister 154.

In certain embodiments, the metal seal (e.g., diaphragm, skin, membrane) that is punctured via the firing pin 134 to release the filling gas or fluid (e.g., carbon dioxide) is coating with a coating material. For example, the coating material may be a paint or other flexible coating material. It has been discovered that such a coating reduces the incidence of metal shards being formed from the punctured seal.

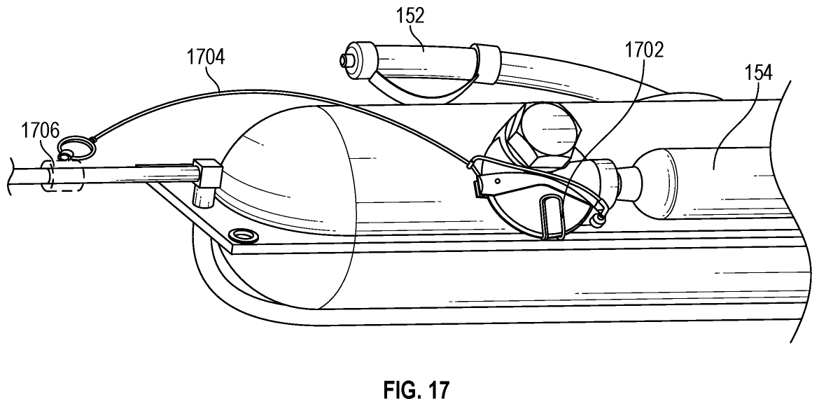

In certain embodiments, as shown in FIG. 17, the inflation mechanism 154 (e.g., gas canister/cartridge) is configured to activate soon after aircraft ejection. Specifically, the connecting feed cable 136 between the ancillary beacon equipment and the inflatable antenna 100 can be used to trigger the inflation mechanism actuator 1702 via a lanyard 1704 affixed to the feed cable 136 by an anchor 1706. For example, the action of unfurling the feed cable 136 could act as a trigger for the actuator 1702. In other embodiments, the inflation mechanism actuator 1702 may be triggered upon contact with water. Also visible in FIG. 17 is an attachment port 152 that may be used for manual inflation of the inflatable antenna.

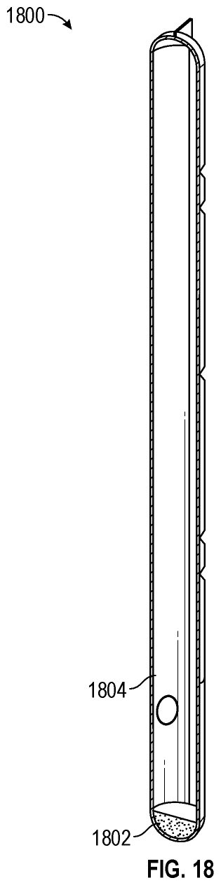

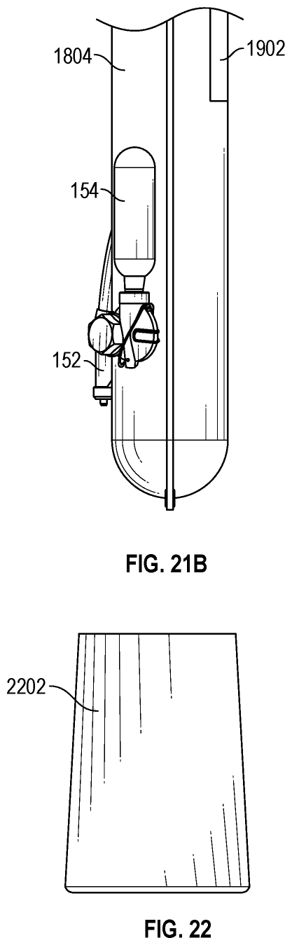

FIGS. 18-21B show one embodiment of an emergency beacon tri-frequency inflatable antenna assembly 1800. FIG. 20 shows the manual inflation tube while FIGS. 21A-B show a CO2 actuator assembly.

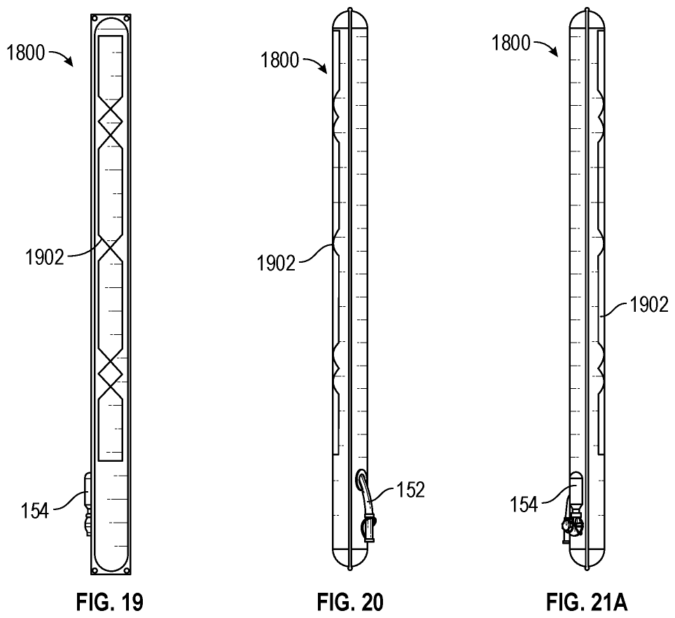

FIG. 18 illustrates a cross-section of one embodiment of an inflatable antenna assembly 1800 having a ballast system to stabilize the three-frequency inflatable beacon antenna as shown in FIGS. 19, 20, and 21A-B. In water, the ballast 1802 beneficially maintains the antenna associated with the elongated sock 1804 above the water line and at an optimized configuration to ensure the delivery of beacon distress radio messages (e.g., so that the radiation comes off the antenna toward the horizon, not vertically, for the search craft). FIG. 18 shows the ballast 1802 at the bottom of the inflation elongated sock 1804, i.e., at the first end of the elongated sock 1804. The ballast 1802 may be any suitable weighting or balance mechanism. As discussed above, the ballast 1802 may be directly or indirectly associated with the elongated sock 1804, such as being contained within the internal volume of the sock, within the stitching or layers of material forming the sock, or attached to an internal or external surface of the sock.

In certain embodiments, as shown in FIGS. 19-21A, the antenna 1902 is dimensioned and positioned relative the inflatable sock 1804 and ballast (not pictured in FIGS. 19-21B) such that, in water, the antenna 1902 is maintained above the water line. In certain embodiments, the antenna 1902 extends along a length of the inflatable sock 1804 that is from about 50 percent to about 100 percent of a length measured between the ballast and a second end of the inflatable sock opposite the first end.

In certain embodiments, the ballast weight has an asymmetric weight profile designed to balance the asymmetric weight on the inflated sock (e.g., antenna or PCB on one side and not the other), so that it is profiled to keep the flotation normal to the surface of the water.

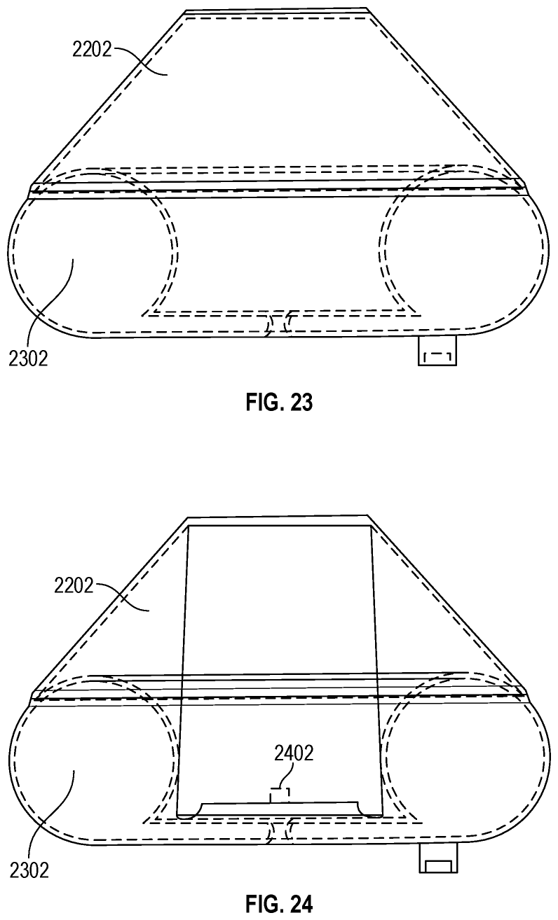

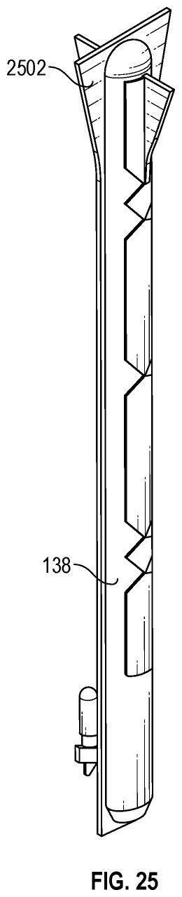

The GPS antenna is a beneficial adjunct for the emergency beacon system. However, such antenna is also prone to sinking, thus defeating the function of position location. The inflatable emergency beacon antenna system described herein can integrate a separate GPS antenna, atop the flotation for optimum satellite reception coverage or with an adjunct flotation for just the GPS antenna. In certain embodiments, the inflatable antenna assembly also includes a Global Positioning System (GPS) antenna located at a second end of the inflatable sock opposite the first end. In certain embodiments, the inflatable antenna assembly also includes a helical GPS antenna disposed within a floatation device. FIG. 22 shows the outline of a commercially available helical GPS antenna 2202. FIG. 23 shows the helical GPS antenna 2202 inside a dedicated flotation device 2302 with a removable protective covering membrane (not pictured). The membrane provides the means of installing the GPS antenna inside the flotation device. FIG. 24 shows a cross section of the GPS flotation device with an annulus 2402 to allow the connecting of coaxial cable back to the beacon system.

In certain embodiments, the inflatable antenna assembly described herein is effective to transmit communications during descent of the antenna during a pilot ejection, parachuting, or similar rescue descent. For example, the descent of the antenna may be subjected to stages. The first stage occurs when the pilot and ejection seat are ejected out of the aircraft and before the parachute opens, during this stage high velocities will be incurred, e.g., >700 MPH (1125 KPH). In this stage, the uninflated antenna (elongated sock) may be streaming (e.g., flowing in the air) during descent with the antenna portion positioned upwardly, relative to the ballast and inflation mechanism. The antenna assembly may be tethered by the connecting feed cable to the beacon, as discussed herein. In such embodiments, it has been found that the inflatable antenna may be stabilized via a stabilization feature such as the fins 2502 positioned at the second end of the elongated sock 138 illustrated in FIG. 25 or a wind sock feature. The fins 2502 illustrated in FIG. 25 have been found to minimize flapping or oscillation of the antenna during descent, which can damage the cables of the assembly.

Next, when the parachute is fully deployed during descent, a sudden breaking effect will cause the antenna to slingshot downward, to assume a “hanging configuration,” with the feed cable between the beacon and the elongated sock, with the antenna/elongated sock hanging up-side down for the slowed descent. This stage will last until hitting the surface of the water, at which point the inflation mechanism may be triggered (automatically or manually, as discussed herein), and the antenna/elongated sock assume an inflated upright floating position. In another embodiment, the inflation mechanism may be automatically triggered when the seat is ejected, which negates the need for the water actuator to have to become exposed and the unfurling of the antenna when it hits water.

In certain embodiments, an emergency position-indicating radio beacon assembly is provided, including an emergency position-indicating radio beacon, any embodiment of the inflatable beacon antenna assembly described herein (including any combinations of features of the various described embodiments), and a feed cable coupled to the beacon and to the antenna assembly, wherein the feed cable is configured to transfer information between the antenna and a transmitter, receiver, or transceiver of the emergency position-indicating radio beacon.

In the embodiments described above, an inflatable antenna assembly 100 is disclosed. In certain embodiments, the assembly 100 may be attached to a structure 132 with fasteners 112 extending from a bag 102 containing the antenna assembly so that the antenna is securely held to the structure. Some of the structures identified above include, but are not limited to, an inflatable life raft, a boat, a shipping container, or other suitable structure. Other suitable structures may include life preservers, life jackets, buoys, and emergency beacons, to name a few. The structures may also be utilized with handheld radios and the like. Going forward, these structures may be identified as safety device structures. As discussed above, the inflatable antenna system may be used to replace existing antenna systems with short length antennas so as to effectively increase the transmission power of the associated transmitter or receiver. As a result, the range of an emergency signal is effectively expanded.

In some embodiments, an inflatable antenna assembly includes a bag (used herein to refer to any suitable container or substrate for the antenna) with a stiffened portion and an inflatable antenna attached to the stiffened portion of the bag. The inflatable antenna includes an inflatable sock with an interior surface and an exterior surface where an antenna extends along the inflatable sock. On the exterior surface of the inflatable sock is an attachment mechanism. An inflation canister may be attached to the attachment mechanism and is configured to inflate the inflatable sock into an inflated state from a deflated state. The aforementioned bag contains the inflatable sock. The bag includes an interior surface and an exterior surface. On the exterior surface of the bag may be a fastener configured to close an interior volume of the bag, a handle coupled to the exterior surface of the bag, and/or a series of loop fastener strips.

In some embodiments, as in FIGS. 3, 5, and 6, an inflatable antenna assembly 100 is provided. The inflatable antenna assembly 100 includes a bag 102, an inflatable antenna 104, and, optionally, a series of other accessories contained on the interior and exterior of the bag 102. In some instances, the bag 102 may include an interior surface 106, which defines an interior volume 128, and an exterior surface 108.

In some instances, the bag 102 may include multiple interior compartments (not shown) (e.g., pockets and/or dividers within the bag 102). The interior surface 106 and the exterior surface 108 may contain a variety of accessories. For example, the bag 102 may contain the inflatable antenna 104 within or on the interior surface 106 along with any additional accessories, such as flashlights, whistles, lighters, flares, knives, rations, or other survival supplies.

In some embodiments, as shown in FIG. 6, the exterior surface 108 of the bag 102 includes a stiffened portion 110, a fastener 112, a handle 114, and a series of loop fastener strips 116, among other accessories. For example, the exterior surface 108 of the bag 102 may contain reflectors, mounting apparatuses, pockets, or other structures on the bag 102. For example, the exterior surface 108 of the bag 102 may include a mounting fastener (not shown), such as a tie, cuff, buckle, clip, or other fastener. The bag 102 may be rigid or flexible. In some instances, the bag 102 may be nylon. In other instances, the bag 102 may be cotton, linen, wool, silk, rayon, acetate, acrylic, polyester, or some combination therein. In certain embodiments, the bag 102 may have a major dimension of about 10 inches or less. One benefit to the bag 102 being composed of nylon fabrics may be the resistance to wind and water damage.

In some embodiments, as shown in FIGS. 5-6, the bag 102 includes a plurality of walls 118. The plurality of walls 118 may form a rectangular prism or another shape, such as a cube, pyramid, cylinder, or other shape. In some instances, the plurality of walls 118 may all be rigid, solid surfaces. In other instances, some of the plurality of walls 118 may be rigid and some of the plurality of walls 118 may be flexible. For example, one wall of the plurality of walls 118 may be a stiffened portion 110. As used herein, the terms “stiffened portion” means the element is rigid under standard environmental conditions no matter the position of the element. In some instances, the stiffened portion 110 provides for a rigid base to allow for improved handling and/or inflation. In other embodiments, every wall in the plurality of walls 118 may be flexible.

The plurality of walls 118, and their respective interior surfaces 106, may form an interior volume 128. In some instances, the interior volume 128 may be open to the outside environment. That is, the inflatable antenna 104 may be coupled only to the stiffened portion 110 that provides partial containment or partial coverage of the antenna. In some embodiments, as shown in FIG. 5, the interior volume 128 of the bag 102 is closed to the outside environment. In some embodiments, a hatch, door, flap, or other suitable structure may be provided to allow for selective access to the interior volume 128. For example, one of the walls in the plurality of walls 118 may actuate about an axis (not shown) to open or close the interior volume 128.

For example, one of the walls may include a fastener 112 configured to snap onto another wall to close the interior volume 128. The fastener 112 may be various types of other attachment mechanisms configured to close the interior volume. For example, the fastener 112 may be a hook-and-loop surface, button, press studs, magnetic snaps, or other attachment mechanism between two walls of the bag 102. In some instances, the plurality of walls 118 may join together by a similar attachment mechanism. For example, each seam 130 in the plurality of walls may have a hook-and-loop attachment between two walls to form the seam 130. One benefit to a hook-and-loop attachment mechanism between two walls may include the walls being easily removed from the bag 102 to release the contents of the bag 102. In other instances, the seams 130 may be formed by buttons, stitching, adhesive, or some other attachment mechanism.

In some embodiments, as shown in FIG. 6, the stiffened portion 110 of the bag 102 includes several accessories disposed thereon. For example, the stiffened portion 110 may include a handle 114 and a series of loop fastener strips 116. The handle 114 may attach to one wall of the plurality of walls 118. For example, the handle 114 may be attached to the stiffened portion 110 of the bag 102. The handle 114 may be configured to be held by a user. For example, when the seams 130 of the bag are ripped apart, the interior volume 128 opened, and the inflatable antenna 104 expanded, a user may hold onto the handle to raise, lower, or adjust the positioning of the inflatable antenna 104 (e.g., as shown in FIG. 6).

In some embodiments, as shown in FIGS. 6 and 8, the stiffened portion 110 includes a series of loop fastener strips 116 configured to attach the bag 102 to a structure 132. In some instances, the structure may be in the form of an inflatable life raft, a boat, a shipping container, or other suitable structure. For example, each loop fastener strip 116 may be a flexible fabric coupled to the bag 102 at one end and extend therefrom. The loop fastener strip 116 may wrap around the structure 132 (e.g., as shown in FIG. 8) to temporarily couple the inflatable antenna assembly 100 to a single, stable position. For example, the loop fastener strip 116 end, opposite the end coupled to the bag 102, may wrap around a structure 132 and attach to a fastener on the bag. For example, the bag 102 may have the loop portion of a hook-and-loop attachment mechanism, and the loop fastener strip 116 may include the hook portion of the hook-and-loop attachment mechanism. In some instances, the hook-and-loop mechanism may be disposed on the bag 102 and loop fastener strip 116 in another fashion.

In some embodiments, as shown in FIG. 3, the bag 102 includes an inflatable antenna 104 and other accessories within the bag 102. The inflatable antenna 104 within the bag may be in a deflated state, and each of the accessories may fit within the closed interior volume 128. For example, an inflation mechanism, such as inflation canister 154 and firing pin 134, a feed cable 136, and other accessories may be disposed therein.

In addition to retrofitting existing structures, the concepts and embodiments described above can be made integral to a safety device structure to further enhance the effectiveness of the inflatable beacon antenna assembly. To that end, all of the features and advantages described above are available to be incorporated into the safety device structures described below. To name a few, the materials used for the sock, the different types of antennas, the connectors employed by the antennas, the feed cables, the valves, and various lights, may be incorporated into any of the embodiments discussed below.

For example, the safety device structure may be an inflatable life raft and the inflatable beacon antenna assembled may optionally be operatively coupled thereto such that the inflatable sock inflates upon inflation of the life raft. In another example, the safety device structure may be a life jacket or life preserver, which may also be referred to as an automatic identification system (AIS), and the inflatable beacon antenna assembled may optionally be operatively coupled thereto such that the inflatable sock inflates upon inflation.

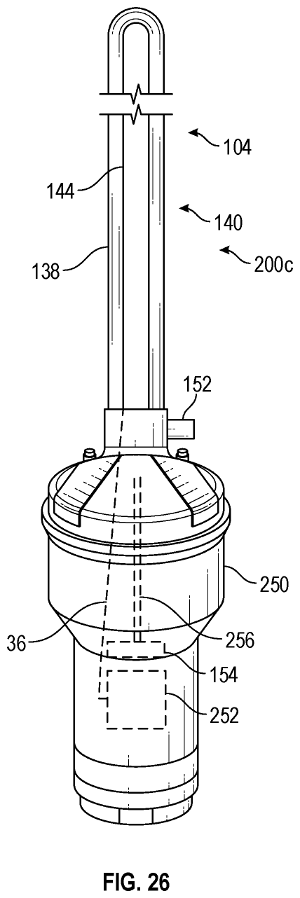

Referring now to FIG. 26, it can be seen that a safety device structure is designated generally by the numeral 200C. In this embodiment, the inflatable antenna 104 is associated with an emergency beacon wherein the emergency beacon may be of any number of configurations. These configurations may be in any form, such as an emergency positioning radio beacon (EPIRB), personal locator beacons (PLB), personal automated identification system (AIS) devices, search and rescue transponders (SART), emergency locator transmitters (ELT), VHF marine radios, and any other transceiver configuration where a compact inflatable antenna is desirable.

Such a structure 200C provides for a housing 250, which may be floatable or not, wherein the housing carries a transmitter/receiver 252, designated as “T/R” in FIG. 26. The inflatable antenna 104 may be coupled to the housing 250 and provides the inflatable sock 138, which may be inflated manually or automatically as described in any of the embodiments above. The inflatable sock 138 carries the antenna 144, which may be a J-type, or other type of antenna as described in the embodiments above. A manual valve 152 may be provided near the base of the inflatable sock to allow for manual inflation thereof. In another embodiment, a compressed gas canister 154, which is connected to a conduit 256 at one end, wherein the other end of the conduit is connected to the inflatable sock 138, may be provided. Mechanisms may be provided within the housing 250 for manual or automatic actuation of the canister to enable inflation of the antenna.

Thus, the described embodiments provide for an increased length multi-frequency beacon antenna, which provides for significantly improved range so as to facilitate search and rescue of individuals on life rafts, life preservers. Further, enclosed antennas, in which the antennas are maintained within a structure which is inflatable and balanced upright via a ballast, may be advantageous in that the antennas are somewhat protected from harsh or adverse conditions that may be encountered during emergency situations, in particular in marine environments. Additionally, the described safety device structures may be advantageous in that such configurations provide for a flexible antenna which allows for the antenna to be exposed to harsh environments, but which is able to deflect at high winds without damage to the antenna itself.

While the disclosure has been described with reference to a number of embodiments, it will be understood by those skilled in the art that the disclosure is not limited to such disclosed embodiments. Rather, the disclosed embodiments can be modified to incorporate any number of variations, alterations, substitutions, or equivalent arrangements not described herein, but which are commensurate with the scope of the disclosure.

What is claimed is:

1. An inflatable beacon antenna assembly, comprising:
an inflatable sock having an inflated state and a deflated state, wherein the inflatable sock assumes an elongated configuration in the inflated state;
a three frequency very high frequency (VHF)/ultra-high frequency (UHF) antenna extending along a length of the inflatable sock;
a ballast at or near a first end of the inflatable sock, the ballast being effective to maintain the antenna assembly upright in water; and
an attachment port configured for operable connection to an inflation mechanism.

2. The assembly of claim 1, further comprising a feed cable coupled to the antenna, wherein the feed cable is configured to transfer information between the antenna and an emergency beacon transmitter, receiver, or transceiver.

3. The assembly of claim 2, wherein the feed cable is a coaxial cable.

4. The assembly of claim 1, wherein the antenna comprises inductor coils to provide functioning of multi-frequency trap circuits, allowing for multi-frequency operation.

5. The assembly of claim 4, wherein the antenna is flexible and the inductor coils are protected by flexible coil forms in the deflated state.

6. The assembly of claim 1, further comprising a frame surrounding at least a portion of the first end of the inflatable sock, the frame comprising an aperture therethrough, the aperture configured to receive a feed cable and/or a cable of the antenna therethrough, to alleviate transfer of forces between said cable and the elongated sock.

7. The assembly of claim 6, wherein the frame is configured such that said cable extends along the elongated sock in a direction parallel to the longitudinal axis of the sock and then turns approximately 90 degrees to extend through the frame at the first end of the elongated sock.

8. The assembly of claim 1, wherein the antenna is dimensioned and positioned relative the inflatable sock and ballast such that, in water, the antenna is maintained above the water line.

9. The assembly of claim 8, wherein the ballast has an asymmetric weight profile.

10. The assembly of claim 8, wherein the antenna extends along a length of the inflatable sock that is from about 50 percent to about 100 percent of a length measured between the ballast and a second end of the inflatable sock opposite the first end.

11. The assembly of claim 1, wherein the antenna comprises a braided copper tape and/or a flexible antenna made from known flexible circuit board techniques.

12. The assembly of claim 1, further comprising a Global Positioning System (GPS) antenna located at a second end of the inflatable sock opposite the first end.

13. The assembly of claim 1, further comprising a helical GPS antenna disposed within a floatation device.

14. The assembly of claim 1, wherein the antenna extends along an inner surface of the inflatable sock.

15. The assembly of claim 1, further comprising a plurality of stabilization fins extending from an outer surface of the elongated sock at or near a second end of the elongated sock, opposite the first end.

16. The assembly of claim 1, further comprising a light and/or flag coupled to the inflatable sock.

17. The assembly of claim 16, wherein the flag is formed of a conductive material or another material that is radar-reflective.

18. The assembly of claim 1, wherein the inflatable sock comprises a fabric material that is waterproof and reflective.

19. The assembly of claim 1, further comprising a mounting fastener at or near the first end of inflatable sock, the mounting fastener being configured for mounting the inflatable beacon antenna assembly to a structure.

20. The assembly of any one of claim 1, further comprising:
an inflation canister coupled to the attachment port and configured to inflate the inflatable sock to assume the inflated state; and
a firing pin coupled to the canister, wherein the firing pin is configured to selectively puncture a seal of the canister to inflate the inflatable sock.

21. The assembly of claim 20, wherein the seal of the canister is formed of a metal material that is coated with a flexible paint or polymer coating material.

22. The assembly of claim 20, wherein the firing pin is configured to be actuated to puncture the seal proximate to aircraft seat ejection.

23. The assembly of claim 22, wherein an unfurling action of a feed cable of the assembly actuates the firing pin to inflate the inflatable sock.

24. The assembly of claim 20, wherein the firing pin is configured to be actuated to puncture the seal upon contact of the assembly with water.

25. The assembly of claim 20, wherein the inflatable sock is further configured for manual inflation.

26. An emergency position-indicating radio beacon assembly, comprising:
an emergency position-indicating radio beacon;
the inflatable beacon antenna assembly of claim 1; and
a feed cable coupled to the beacon and to the antenna assembly,
wherein the feed cable is configured to transfer information between the antenna and a transmitter, receiver, or transceiver of the emergency position-indicating radio beacon.

27. An structural assembly, comprising:
a structural component; and
the inflatable beacon antenna assembly of claim 1, mounted on the structural component.

28. The structural assembly of claim 27, wherein the structural component comprises an inflatable life raft or a shipping container.

29. The structural assembly of claim 27, wherein the structural component is an inflatable life raft and the inflatable beacon antenna assembled is operatively coupled thereto such that the inflatable sock inflates upon inflation of the life raft.
